(19) United States
(12) Patent Application Publication
(10) Pub. No.: US 2006/0267919 A1
(43) Pub. Date: Nov. 30, 2006

(54) Backlight unit having surface luminescence structure

(76) Inventors: Shang-Hyeun Park, Yongin-si (KR); Tae-Won Jeong, Seoul (KR); Jeong-Na Heo, Yongin-si (KR); Jeong-Hee Lee, Seongnam-si (KR); Kyoung-Won Min, Icheon-si (KR)

Correspondence Address: Robert E. Bushnell, Suite 300, 1522 K Street, N.W., Washington, DC, 20005-1202, US

(21) Appl. No.: 11/395,326

(22) Filed: Apr. 3, 2006

(30) Foreign Application Priority Data
May 10, 2005 (KR) 10-2005-0038989

(51) Int. Cl. G09G 3/36

(52) U.S. Cl. 345/102

(57) ABSTRACT

A backlight unit having a surface luminescence structure includes: a first substrate; a first electrode arranged on a lower surface of the first substrate; a first mixed layer arranged on a lower surface of the first electrode, and including emitters and phosphors; a second substrate arranged to face the first substrate; a second electrode arranged on an upper surface of the second substrate; and a second mixed layer arranged on an upper surface of the second electrode, and including emitters and phosphors. The backlight unit can be easily manufactured at a low cost, and the light emission efficiency and brightness characteristics of the backlight unit are maximized.

### CLAIM OF PRIORITY

This application makes reference to, incorporates the same herein, and claims all benefits accruing under 35 U.S.C. §119 from an application for BACK LIGHT UNIT WITH STRUCTURE FOR SURFACE LUMINESCENCE earlier filed in the Korean Intellectual Property Office on the 10th of May 2005 and there, duly assigned Ser. No. 10-2005-0038989.

### BACKGROUND OF THE INVENTION

1. Field of the Invention

The present invention relates to a backlight unit, and more particularly, to a backlight unit having a surface luminescence structure.

2. Description of the Related Art

Flat panel displays can be divided into emissive displays and passive displays. Emissive displays include Cathode Ray Tubes (CRTs), Plasma Display Panels (PDPs), and Field Emission Displays (FEDs), and passive displays include Liquid Crystal Displays (LCDs). An LCD has the advantages of lightweight and low power consumption, but is a passive display. That is, the LCD displays an image using light incident from the outside, not by self-luminescence. Therefore, the image cannot be seen in a dark place. To solve this disadvantage, a backlight unit is installed behind the LCD, to radiate light and allow the LCD to realize an image in the dark.

Conventional backlight units mainly use Cold Cathode Fluorescent Lamps (CCFLs) for a line luminescence method and Light Emitting Diodes (LEDs) for a point luminescence method. However, conventional backlight units have high manufacturing costs due to their structural complexity, and high power consumption due to light reflection and transmittance caused by the light source located on a side of the backlight unit. In particular, as the size of an LCD increases, the achievement of uniform brightness is more difficult.

Recently, to solve the above drawbacks, a surface luminescence backlight unit has been proposed. A surface luminescence backlight unit uses the field emission of Carbon NanoTubes (CNTs), and has the advantages of lower power consumption and relatively uniform brightness over a wide light emitting region as compared to conventional backlight units using CCFLs.

According to the recent trend, backlight units having a structure that can be easily manufactured at a low cost and can improve brightness characteristics have been proposed. Therefore, there is a need to develop a backlight unit structure that can maximize the advantages listed above.

### SUMMARY OF THE INVENTION

The present invention provides a backlight unit having a surface luminescence structure that can be easily manufactured at a low cost and which maximizes efficiency and brightness characteristics.

According to one aspect of the present invention, a backlight unit having a surface luminescence structure is provided, the backlight unit including: a first substrate; a first electrode arranged on a lower surface of the first substrate; a first mixed layer arranged on a lower surface of the first electrode, and including emitters and phosphors; a second substrate arranged to face the first substrate; a second electrode arranged on an upper surface of the second substrate; and a second mixed layer arranged on an upper surface of the second electrode, and including emitters and phosphors.

The first and second mixed layers preferably respectively include a paste, consisting of a mixture of the emitters and phosphors, coated on the first and second electrodes and fired. The first and second mixed layers are preferably respectively coated on the first and second electrodes by one of screen printing, doctor blade, spin coating, and spraying.

The emitters of each of the first and second mixed layers preferably include Carbon NanoTubes (CNTs).

The first mixed layer preferably includes a first emitter layer and a first phosphor layer respectively including the emitters and phosphors and arranged on the lower surface of the first electrode, and the second mixed layer preferably includes a second emitter layer and a second phosphor layer respectively including the emitters and phosphors and arranged on the upper surface of the second electrode, and the first emitter layer is preferably arranged to face the second phosphor layer, and the first phosphor layer is preferably arranged to face the second emitter layer.

A plurality of the first emitter layers and the first phosphor layers are preferably arranged alternately, and a plurality of the second emitter layers and the second phosphor layers are preferably arranged alternately.

The emitters contained in each of the first and second emitter layers preferably include Carbon NanoTubes (CNTs).

The backlight unit preferably further includes spacers interposed between the first substrate and the second substrate and adapted to separate the first mixed layer from the second mixed layer.

At least one of the first substrate and the second substrate preferably includes transparent glass.

The first and second electrodes preferably include Indium Tin Oxide (ITO). The first and second electrodes are preferably adapted to receive an AC voltage therebetween.

The phosphors preferably include a mixture of red, green, and blue phosphors. The phosphors alternatively preferably include one phosphor selected from the group consisting of red, green, and blue phosphors.

According to another aspect of the present invention, a backlight unit having a surface luminescence structure is provided, the backlight unit including: a cylindrical substrate having an inner space; a first electrode arranged on an inner surface of the substrate along the length direction of the substrate; a first mixed layer arranged on a surface of the first electrode and including emitters and phosphors; a second electrode arranged on the inner surface of the substrate along the length direction of the substrate and apart from the first electrode; and a second mixed layer arranged on a surface of the second electrode and including emitters and phosphors.

The first and second mixed layers preferably respectively include a paste, consisting of a mixture of the emitters and phosphors, coated on the first and second electrodes and fired. The first and second mixed layers are preferably respectively coated on the first and second electrodes by one of screen printing, doctor blade, spin coating, and spraying.

The emitters of each of the first and second mixed layers preferably include Carbon NanoTubes (CNTs).

The first mixed layer preferably includes a first emitter layer and a first phosphor layer respectively including the emitters and phosphors and arranged on the lower surface of the first electrode, and the second mixed layer preferably includes a second emitter layer and a second phosphor layer respectively including the emitters and phosphors and arranged on the upper surface of the second electrode, and the first emitter layer is preferably arranged to face the second phosphor layer, and the first phosphor layer is preferably arranged to face the second emitter layer.

A plurality of the first emitter layers and the first phosphor layers are preferably arranged alternately, and a plurality of the second emitter layers and the second phosphor layers are preferably arranged alternately.

The emitters contained in each of the first and second emitter layers preferably include Carbon NanoTubes (CNTs).

The substrate preferably includes transparent glass.

The first and second electrodes preferably include Indium Tin Oxide (ITO). The first and second electrodes are preferably adapted to receive an AC voltage therebetween.

The phosphors preferably include a mixture of red, green, and blue phosphors. The phosphors alternatively preferably include one phosphor selected from the group consisting of red, green, and blue phosphors.

### BRIEF DESCRIPTION OF THE DRAWINGS

A more complete appreciation of the present invention and many of the attendant advantages thereof will be readily apparent as the present invention becomes better understood by reference to the following detailed description when considered in conjunction with the accompanying drawings in which like reference symbols indicate the same or similar components, wherein:

FIG. 1 is an exploded perspective view of a backlight unit having a surface luminescence structure according to an embodiment of the present invention;

FIG. 2 is a cross-sectional view taken along the line II-II of FIG. 1;

FIG. 3 is an exploded perspective view of a backlight unit having a surface luminescence structure according to another embodiment of the present invention;

FIG. 4 is a cross-sectional view taken along the line IV-IV of FIG. 3;

FIG. 5 is an exploded perspective view of a backlight unit having a surface luminescence structure according to still another embodiment of the present invention; and

FIG. 6 is a cross-sectional view taken along the line VI-VI of FIG. 5.

### DETAILED DESCRIPTION OF THE INVENTION

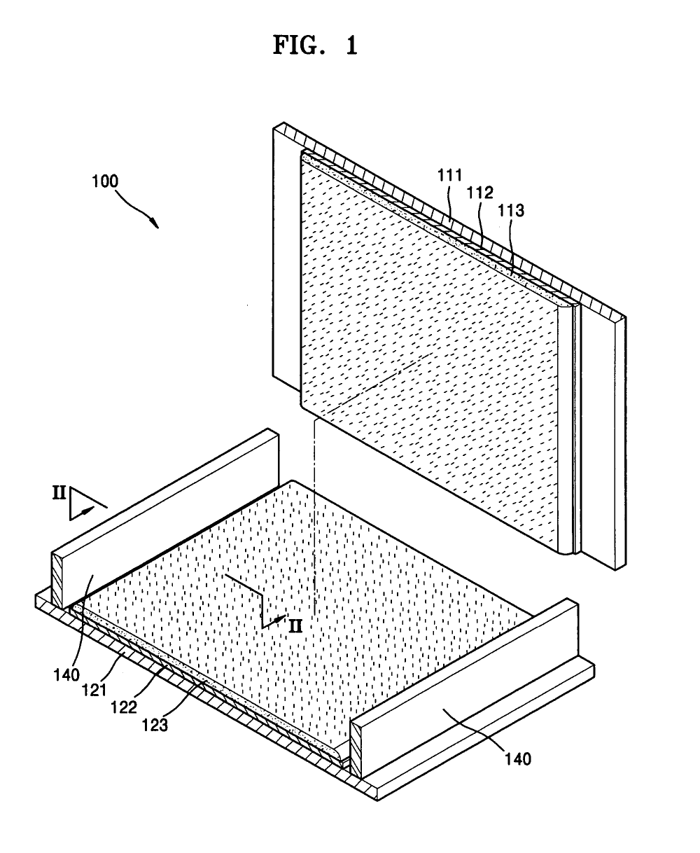

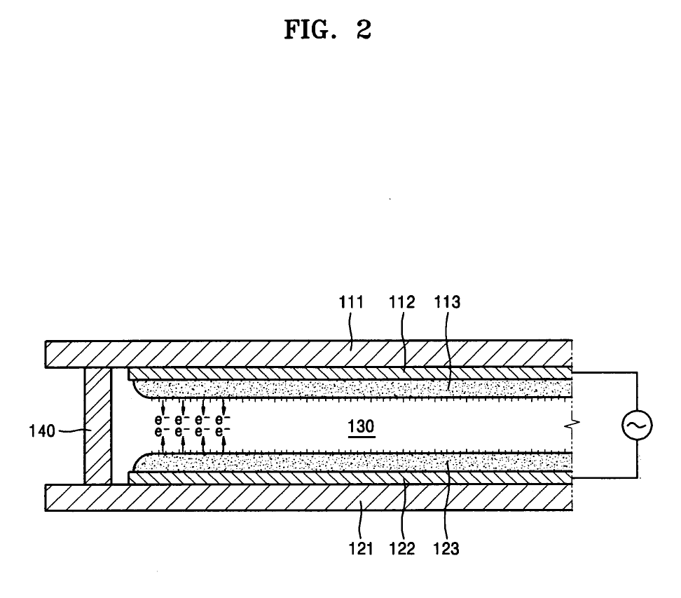

FIG. 1 is an exploded perspective view of a backlight unit having a surface luminescence structure according to an embodiment of the present invention, and FIG. 2 is a cross-sectional view taken along the line II-II of FIG. 1.

Referring to FIGS. 1 and 2, a backlight unit 100 having a surface luminescence structure according to an embodiment of the present invention includes a first substrate 111 and a second substrate 121 spaced apart from each other by a predetermined distance and facing each other.

At least one of the first substrate 111 and the second substrate 121 is formed of transparent glass to transmit light emitted from a phosphor. A first electrode 112 and a first mixed layer 113 are stacked sequentially on the lower surface of the first substrate 111, and a second electrode 122 and a second mixed layer 123 are stacked sequentially on the upper surface of the second substrate 121.

The first electrode 112 is formed to a uniform thickness over a predetermined region on the lower surface of the first substrate 111, and the second electrode 122 is formed to a uniform thickness over a region of the upper surface of the second substrate 121 corresponding to the region where the first electrode 112 is formed. The first electrode 112 and the second electrode 122 can be formed of a transparent conductive material, such as Indium Tin Oxide (ITO), to transmit visible light emitted from the phosphor. On the other hand, when one of the first substrate 111 and the second substrate 121 is formed of an opaque material, the electrode to be formed on the opaque substrate can be formed of an opaque conductive material, such as a metal, instead of ITO. When both the first electrode 112 and the second electrode 122 are formed of ITO, the line resistance of the first electrode 112 and the second electrode 122 is relatively high. To compensate for this, a metal electrode that can serve as a bus electrode can be connected to at least one of the first electrode 112 and the second electrode 122.

The first mixed layer 113 is formed to a uniform thickness over a predetermined region on the lower surface of the first electrode 112. The second mixed layer 123 is formed to a uniform thickness over a region of the upper surface of the second electrode 122 corresponding to the region where the first mixed layer 113 is formed. That is, the size of the region on which the first mixed layer 113 is formed is approximately the same as the size of the region on which the second mixed layer 123 is formed, and the first mixed layer 113 and the second mixed layer 123 are arranged to face each other.

Each of the first mixed layer 113 and the second mixed layer 123 includes an emitter and a phosphor. The emitter emits electrons due to an electric field formed by a voltage supplied between the first electrode 112 and the second electrode 122. The emitter can be formed of CNT which has high electron emission capability at a relatively low driving voltage. The phosphor can be a mixture of red, green, and blue phosphors that respectively generate red, green, and blue light when they are excited by the electrons emitted from the emitter, or can be a phosphor selected from the group consisting of a red phosphor, a green phosphor, and a blue phosphor.

According to the present embodiment, the CNT and the phosphor are present in a mixed state in the first mixed layer 113 and the second mixed layer 123. The first mixed layer 113 and the second mixed layer 123 having such structures can be formed by various methods. An exemplary method will be described below.

First, the CNT and the phosphor are ground in a powder. The CNT and phosphor powders are mixed with a binder to form a paste. Afterward, the CNT and phosphor paste is coated on the lower surface of the first electrode 112 and the upper surface of the second electrode 122, and the resultant products are fired. As a result, the first mixed layer 113 and the second mixed layer 123 in which the CNT and the phosphor are mixed as described above are obtained. A method of coating the paste of CNT and phosphor on the surfaces of the first electrode 112 and the second electrode 122 can be one of screen printing, doctor blade, spin coating, and spraying. As described above, since the first mixed layer 113 and the second mixed layer 123 can be manufactured at once using the paste of CNT and phosphor, they can be easily manufactured at a low cost.

Since the first mixed layer 113 and the second mixed layer 123 have the structures described above, as illustrated in FIG. 2, electrons emitted from the emitter of the first mixed layer 113 excite the phosphor of the second mixed layer 123 on the opposite side of the first mixed layer 113 to generate visible light, and at the same time, electrons emitted from the emitter of the second mixed layer 123 excite the phosphor of the first mixed layer 113 on the opposite side of the second mixed layer 123 to generate visible light. The emitter of the first mixed layer 113 and the emitter of the second mixed layer 123 are respectively distributed on the entire surfaces of the first mixed layer 113 and the second mixed layer 123. Accordingly, the electrons are emitted from the entire surface of each of the first mixed layer 113 and the second mixed layer 123. The emitted electrons excite the phosphors respectively distributed on the entire surfaces of the first mixed layer 113 and the second mixed layer 123 to generate visible light. Accordingly, surface luminescence can be realized through the first substrate 111 and/or the second substrate 121, and brightness is uniform over the entire light emitting surface. Furthermore, the brightness characteristics and emission efficiency of the backlight unit can be maximized since visible light is generated from both the first mixed layer 113 and the second mixed layer 123.

As described above, the first electrode 112 and the second electrode 122 are needed to alternately serve as a cathode electrode and an anode electrode so that the emitter included in each of the first mixed layer 113 and the second mixed layer 123 can emit electrons. For this purpose, as depicted in FIG. 2, an AC voltage is supplied between the first electrode 112 and the second electrode 122.

As depicted in FIG. 2, spacers 140 are interposed between the first substrate 111 and the second substrate 121 to provide a space 130 for field emission between the first and second mixed layers 113 and 123. The spacers 140 separate the first mixed layer 113 from the second mixed layer 123 to form the space 130 between the first and second mixed layers 113 and 123. The spacers 140 are located in appropriate positions between the first and second substrates 111 and 121 to maintain the gap between the first and second mixed layers 113 and 123. The first substrate 111 and the second substrate 121 arranged with the spacers 140 therebetween are sealed by a sealing member (not shown) formed along the edges of the first and second substrates 111 and 121.

The operation of the backlight unit having the surface luminescence structure according to an embodiment of the present invention is as follows.

When an AC voltage is supplied between the first and second electrodes 112 and 122, the first electrode 112 and the second electrode 122 alternately serve as a cathode electrode and an anode electrode. That is, when the first electrode 112 serves as the cathode electrode and the second electrode 122 serves as the anode electrode, the emitter of the first mixed layer 113 formed on the first electrode 112 emits electrons. When the first electrode 112 serves as the anode electrode and the second electrode 122 serves as the cathode electrode, the emitter of the second mixed layer 123 formed on the second electrode 122 emits electrons. When this process is repeated, the emitter of the first mixed layer 113 and the emitter of the second mixed layer 123 emit electrons. The electrons emitted from the emitter of the first mixed layer 113 collide with the phosphors of the second mixed layer 123, and the electrons emitted from the emitter of the second mixed layer 123 collide with the phosphors of the first mixed layer 113. Accordingly, the phosphors of the first mixed layer 113 and the phosphors of the second mixed layer 123 are excited. Thus, visible light having uniform and high brightness can be generated by the entire light emitting surface.

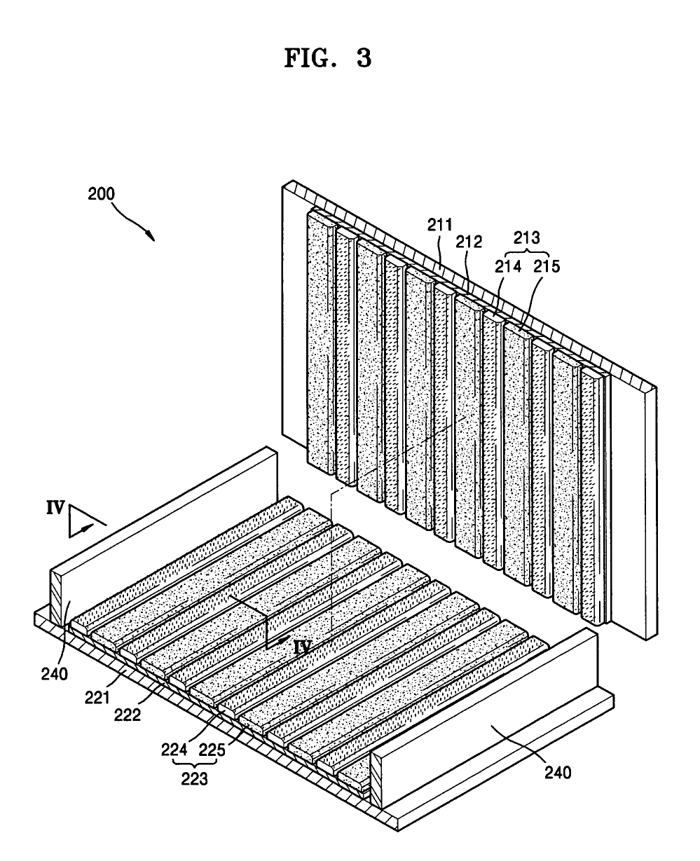

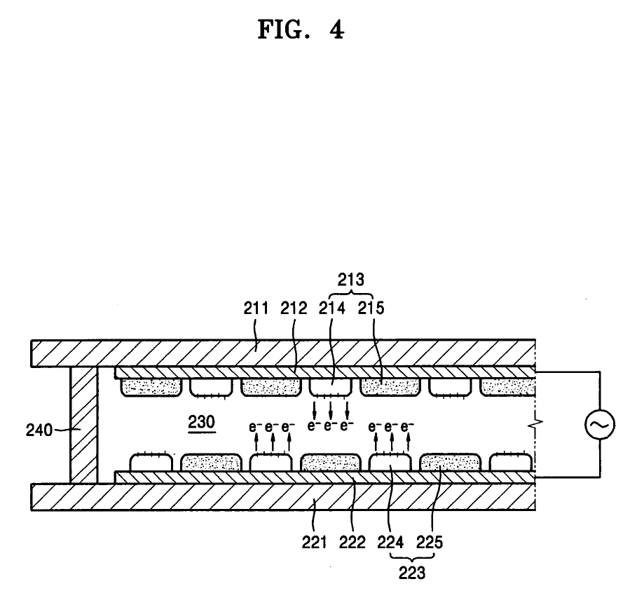

FIG. 3 is an exploded perspective view of a backlight unit having a surface luminescence structure according to another embodiment of the present invention, and FIG. 4 is a cross-sectional view taken along the line IV-IV of FIG. 3.

Referring to FIGS. 3 and 4, a backlight unit 200 having a surface luminescence structure according to another embodiment ofthe present invention includes a first substrate 211 and a second substrate 221 spaced apart from each other by a predetermined distance and facing each other. A first electrode 212 and a first mixed layer 213 are stacked sequentially on the lower surface of the first substrate 211, and a second electrode 222 and a second mixed layer 223 are stacked sequentially on the upper surface of the second substrate 221. Spacers 240 are interposed between the first and second substrates 211 and 221 to separate the first mixed layer 213 from the second mixed layer 223 by a predetermined space 230.

As in the embodiment of FIG. 1, at least one of the first substrate 211 and the second substrate 221 can be formed of transparent glass. The first electrode 212 and the second electrode 222 can be respectively formed of ITO with a uniform thickness over a predetermined region on the lower surface of the first substrate 111 and the upper surface of the second substrate 121.

However, according to the present embodiment, the first mixed layer 213 includes a first emitter layer 214 composed of an emitter material and a first phosphor layer 215 composed of phosphors. The first emitter layer 214 and the first phosphor layer 215 are arranged on the lower surface of the first electrode 212, that is, on the same plane. The second mixed layer 223 includes a second emitter layer 224 composed of an emitter material and a second phosphor layer 225 composed of phosphors. The second emitter layer 224 and the second phosphor layer 225 are formed on the upper surface of the second electrode 222. The first emitter layer 214 is arranged to face the second phosphor layer 225, and the first phosphor layer 215 is arranged to face the second emitter layer 224.

As depicted in FIG. 3, a plurality of first emitter layers 214 and first phosphor layers 215 can be formed, and also, a plurality of second emitter layers 224 and second phosphor layers 225 can be formed. The first emitter layers 214 and the first phosphor layers 215 are arranged alternately, and the second emitter layers 224 and the second phosphor layers 225 are also arranged alternately. Also, in this case, the first emitter layers 214 are arranged to face the second phosphor layers 225, and the first phosphor layers 215 are arranged to face the second emitter layers 224. The height and width of the first and second emitter layers 214 and 224 and the first and second phosphor layers 215 and 225 depicted in FIGS. 3 and 4 are merely examples, and the present invention is not limited thereto.

The emitter in FIG. 3 can be formed of CNT as in the embodiment of FIG. 1. The phosphor layers in FIG. 3 can be a mixture of red, green and blue phosphors, or can be a phosphor selected from the group consisting of a red phosphor, a green phosphor, and a blue phosphor.

If the first emitter layer 214 and the second emitter layer 224 are formed of CNT, the first emitter layer 214 and the second emitter layer 224 can be formed by coating a CNT paste on the lower surface of the first electrode 212 and the upper surface of the second electrode 222 and firing the coated CNT paste. The first phosphor layer 215 and the second phosphor layer 225 can also be formed by coating a phosphor paste on the lower surface of the first electrode 212 and an upper surface of the second electrode 222 and firing the coated phosphor paste. As described above, the first and second emitter layers 214 and 224 and the first and second phosphor layers 215 and 225 can be easily manufactured at a low cost, since they can be manufactured using the CNT paste and the phosphor paste.

Since the first mixed layer 213 and the second mixed layer 223 have the structures described above, as illustrated in FIG. 4, when an AC voltage is supplied between the first and second electrodes 212 and 222, the first and second mixed layers 213 and 223 operate as follows.

When the first electrode 212 serves as a cathode electrode and the second electrode 222 serves as an anode electrode, electrons are emitted from the first emitter layers 214 of the first mixed layer 213 and excite the second phosphor layers 225 of the second mixed layer 223 on the opposite side of the first mixed layer 213 to generate visible light. Next, when the first electrode 212 serves as the anode electrode and the second electrode 222 serves as the cathode electrode, electrons are emitted from the second emitter layers 224 of the second mixed layer 223 and excite the first phosphor layers 215 of the first mixed layer 213 on the opposite side of the second mixed layer 223 to generate visible light. Accordingly, surface luminescence can be realized through the first substrate 211 and/or the second substrate 221, and brightness is uniform over the entire light emitting surface. Furthermore, the brightness characteristics and emission efficiency of the backlight unit 200 can be maximized since visible light is generated by both the first and second mixed layers 213 and 223.

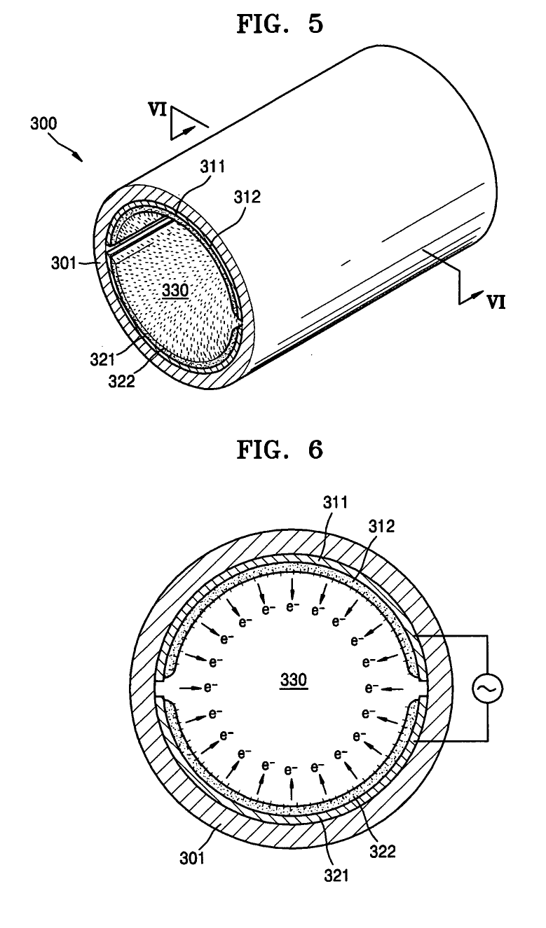

FIG. 5 is an exploded perspective view of a backlight unit having a surface luminescence structure according to still another embodiment ofthe present invention, and FIG. 6 is a cross-sectional view taken along the line VI-VI of FIG. 5.

Referring to FIGS. 5 and 6, a backlight unit 300 having a surface luminescence structure according to still another embodiment of the present invention includes a cylindrical substrate 301 having an inner space 330. The substrate 301 can be formed of transparent glass to transmit visible light emitted from phosphors.

First and second electrodes 311 and 321 are formed on the inner surface of the substrate 301, and are located a predetermined distance apart from each other. The first and second electrodes 311 and 321 have a predetermined width and a uniform thickness, and are formed parallel to the length direction ofthe substrate 301. The first and second electrodes 311 and 321 can be formed of ITO as in the above embodiments.

A first mixed layer 312 is formed on the surface of the first electrode 311, and a second mixed layer 322 is formed on the surface of the second electrode 321. The first mixed layer 312 and the second mixed layer 322 are arranged to face each other. An emitter and phosphors are included in each of the first mixed layer 312 and the second mixed layer 322. Here, as in the embodiments described above, the emitter can be formed of CNT, and the phosphors can be a mixture of red, green, and blue phosphors, or can be a phosphor selected from the group consisting of red, green, and blue phosphors.

As depicted in FIGS. 5 and 6, the first mixed layer 312 and the second mixed layer 322 can be constructed as in the embodiment of FIGS. 1 and 2. That is, a mixture of CNT and phosphors can be in the first mixed layer 312 and the second mixed layer 322. The first mixed layer 312 and the second mixed layer 322 can be formed by coating a paste prepared by mixing CNT and phosphors on the lower surface of the first electrode 311 and the upper surface of the second electrode 321 and firing the coated paste. In this way, since the first mixed layer 312 and the second mixed layer 322 can be manufactured at once using the paste prepared by mixing the CNT and the phosphors, they can be easily manufactured at a low cost.

The first mixed layer 312 and the second mixed layer 322 have the structures described above. When an AC voltage is supplied between the first electrode 311 and the second electrode 321, the first mixed layer 312 and the second mixed layer 322 operate as follows.

When the first electrode 311 serves as a cathode electrode and the second electrode 321 serves as an anode electrode, electrons are emitted from the emitter of the first mixed layer 312 and excite the phosphors of the second mixed layer 322 on the opposite side of the first mixed layer 312 to generate visible light. Next, when the first electrode 311 serves as the anode electrode and the second electrode 321 serves as the cathode electrode, electrons are emitted from the emitter of the second mixed layer 322 and excite the phosphors of the first mixed layer 312 on the opposite side of the second mixed layer 322 to generate visible light. Accordingly, surface luminescence can be realized through the substrate 301, and brightness is uniform over the entire light emitting surface. Furthermore, the brightness characteristics and emission efficiency of the backlight unit 300 can be maximized since visible light is generated by both the first mixed layer 312 and the second mixed layer 322. On the other hand, the first mixed layer 312 and the second mixed layer 322 can be configured as in the embodiment of FIGS. 3 and 4.

According to the present invention, the surface luminescence of a backlight unit through a substrate can be realized. The backlight unit can be easily manufactured at a low cost by forming a mixed layer including an emitter and phosphors. In the backlight unit according to the present invention, mixed layers that can serve as an electron emitter and visible light generator are disposed on both sides of the backlight unit to face each other, so that visible light can be generated on both sides of the backlight unit, thereby maximizing the brightness characteristics and emission efficiency of the backlight unit.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A backlight unit having a surface luminescence structure, the backlight unit comprising:
a first substrate;
a first electrode arranged on a lower surface of the first substrate;
a first mixed layer arranged on a lower surface of the first electrode, and including emitters and phosphors;
a second substrate arranged to face the first substrate;
a second electrode arranged on an upper surface of the second substrate; and
a second mixed layer arranged on an upper surface ofthe second electrode, and including emitters and phosphors.

2. The backlight unit of claim 1, wherein the first and second mixed layers respectively comprise a paste, consisting of a mixture of the emitters and phosphors, coated on the first and second electrodes and fired.

3. The backlight unit of claim 2, wherein the first and second mixed layers are respectively coated on the first and second electrodes by one of screen printing, doctor blade, spin coating, and spraying.

4. The backlight unit of claim 2, wherein the emitters of each of the first and second mixed layers comprise Carbon NanoTubes (CNTs).

5. The backlight unit of claim 1, wherein the first mixed layer comprises a first emitter layer and a first phosphor layer respectively including the emitters and phosphors and arranged on the lower surface of the first electrode, and the second mixed layer comprises a second emitter layer and a second phosphor layer respectively including the emitters and phosphors and arranged on the upper surface of the second electrode, and wherein the first emitter layer is arranged to face the second phosphor layer, and the first phosphor layer is arranged to face the second emitter layer.

6. The backlight unit of claim 5, wherein a plurality of the first emitter layers and the first phosphor layers are arranged alternately, and wherein a plurality of the second emitter layers and the second phosphor layers are arranged alternately.

7. The backlight unit of claim 5, wherein the emitters contained in each of the first and second emitter layers comprise Carbon NanoTubes (CNTs).

8. The backlight unit of claim 1, further comprising spacers interposed between the first substrate and the second substrate and adapted to separate the first mixed layer from the second mixed layer.

9. The backlight unit of claim 1, wherein at least one of the first substrate and the second substrate comprises transparent glass.

10. The backlight unit of claim 9, wherein the first and second electrodes comprise Indium Tin Oxide (ITO).

11. The backlight unit of claim 1, wherein the first and second electrodes are adapted to receive an AC voltage therebetween.

12. The backlight unit of claim 1, wherein the phosphors comprise a mixture of red, green, and blue phosphors.

13. The backlight unit of claim 1, wherein the phosphors comprise one phosphor selected from the group consisting of red, green, and blue phosphors.

14. A backlight unit having a surface luminescence structure, the backlight unit comprising:
a cylindrical substrate having an inner space;
a first electrode arranged on an inner surface of the substrate along the length direction of the substrate;
a first mixed layer arranged on a surface of the first electrode and including emitters and phosphors;
a second electrode arranged on the inner surface of the substrate along the length direction of the substrate and apart from the first electrode; and
a second mixed layer arranged on a surface of the second electrode and including emitters and phosphors.

15. The backlight unit of claim 14, wherein the first and second mixed layers respectively comprise a paste, consisting of a mixture of the emitters and phosphors, coated on the first and second electrodes and fired.

16. The backlight unit of claim 15, wherein the first and second mixed layers are respectively coated on the first and second electrodes by one of screen printing, doctor blade, spin coating, and spraying.

17. The backlight unit of claim 15, wherein the emitters of each of the first and second mixed layers comprise Carbon NanoTubes (CNTs).

18. The backlight unit of claim 14, wherein the first mixed layer comprises a first emitter layer and a first phosphor layer respectively including the emitters and phosphors and arranged on the lower surface of the first electrode, and the second mixed layer comprises a second emitter layer and a second phosphor layer respectively including the emitters and phosphors and arranged on the upper surface of the second electrode, and wherein the first emitter layer is arranged to face the second phosphor layer, and the first phosphor layer is arranged to face the second emitter layer.

19. The backlight unit of claim 18, wherein a plurality of the first emitter layers and the first phosphor layers are arranged alternately, and wherein a plurality of the second emitter layers and the second phosphor layers are arranged alternately.

20. The backlight unit of claim 18, wherein the emitters contained in each of the first and second emitter layers comprise Carbon NanoTubes (CNTs).

21. The backlight unit of claim 1, wherein the substrate comprises transparent glass.

22. The backlight unit of claim 21, wherein the first and second electrodes comprise Indium Tin Oxide (ITO).

23. The backlight unit of claim 14, wherein the first and second electrodes are adapted to receive an AC voltage therebetween.

24. The backlight unit of claim 14, wherein the phosphors comprise a mixture of red, green, and blue phosphors.

25. The backlight unit of claim 14, wherein the phosphors comprise one phosphor selected from the group consisting of red, green, and blue phosphors.
